(19) United States
(12) Patent Application Publication
(10) Pub. No.: US 2009/0044203 A1
(43) Pub. Date: Feb. 12, 2009

(54) Apparatus and Method for Generating Programming Interactions for a Computer Program from an Incoming Data Structure

(76) Inventors: Warren Patrick Acker, Oronoco, MN (US); Richard Joseph Stevens, Rochester, MN (US)

Correspondence Address: MARTIN & ASSOCIATES, LLC, P.O. BOX 548, CARTHAGE, MO, 64836-0548, US

(21) Appl. No.: 11/836,859

(22) Filed: Aug. 10, 2007

(51) Int. Cl. G06F 9/44

(52) U.S. Cl. 719/320

(57) ABSTRACT

A user generates a mapping script using a mapping script generation mechanism. The mapping script is in a format that allows the mapping script to be generated and maintained by a non-programmer. A mapping engine reads a mapping script, reads an incoming data structure, and generates calls to an application interface that allows the incoming data structure to interact with the application. The mapping engine is a computer program, but does not need to change with different incoming data structures and different applications. The logic for mapping between a particular incoming data structure and a particular application is encapsulated in the mapping script, which is in a format that may be easily defined and maintained by a non-programmer. The mapping script may optionally include various mechanisms including a data conversion mechanism, a literal value mechanism, a conditional logic mechanism, and a mapping script selection mechanism.

### BACKGROUND

1. Technical Field

This disclosure generally relates to computer systems, and more specifically relates to ways to execute a computer program.

2. Background Art

Computer programs provide various different functions to users. Many older computer programs need to interact with new technologies, such as web applications. One known way to allow executing an existing computer program using inputs from web applications is to custom-program adapter code that generates appropriate calls to the application based on an incoming data structure, such as a data stream in eXtensible Markup Language (XML) format. By generating programming interactions from an incoming data structure, the adapter code provides an interface between a web application and an older computer program, such as a legacy computer program.

One problem with custom-programming adapter code as discussed above is the maintenance of the adapter code. If the incoming data structure changes, the adapter code must be updated to address the change in the incoming data structure. This requires a skilled programmer to maintain the adapter code so it provides the desired functions as conditions evolve over time. Another problem with custom-programming adapter code is that different adapter code is required for each incoming data structure/computer program combination. Thus, if two different incoming data structures need to communicate with three different computer programs, a total of six different adapters must be custom-programmed to provide the needed functionality, and each of these six adapters must then be separately maintained. Without a way to generate programming interactions for a computer program from an incoming data structure without using custom-programmed code, the computer industry will have to continue to develop and maintain a large number of customer adapters.

### BRIEF SUMMARY

A user generates a mapping script using a mapping script generation mechanism. The mapping script is in a format that allows the mapping script to be generated and maintained by a non-programmer. A mapping engine reads a mapping script, reads an incoming data structure, and generates calls to an application interface that allows the incoming data structure to interact with the application. The mapping engine is a computer program, but does not need to change with different incoming data structures and different applications. The logic for mapping between a particular incoming data structure and a particular application is encapsulated in the mapping script, which is in a format that may be easily defined and maintained by a non-programmer. The result is a separation of programming logic that does not change in the mapping engine and the logic for performing the mapping in the mapping script, thereby providing a system that may be maintained by a non-programmer. The mapping script may optionally include various mechanisms including a data conversion mechanism, a literal value mechanism, a conditional logic mechanism, and a mapping script selection mechanism as described in more detail below.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that performs mapping of an incoming data structure to an application interface;

FIG. 2 is a block diagram of a prior art system for performing mapping of an incoming data structure to an application interface;

FIG. 3 is a flow diagram of a prior art method for generating the custom adapter code shown in FIG. 2;

FIG. 4 is a block diagram of a system for performing mapping of an incoming data structure to an application interface using a user-defined mapping script and a mapping engine;

FIG. 5 is a flow diagram of a method for a user to define a mapping script;

FIG. 6 is a flow diagram of a method for the mapping engine in FIG. 4 to automatically generate application interface calls from the incoming data structure and from the mapping script;

FIG. 7 is a sample incoming data structure in XML format;

FIG. 8 is a sample application interface definition;

FIG. 9 is a sample mapping script;

FIG. 10 is a sample set of application interface calls generated by the mapping engine from the sample incoming data structure in FIG. 7 and the sample mapping script in FIG. 9;

FIG. 11 shows optional mechanisms that may be included in a mapping script; and

FIG. 12 is a sample graphical user interface that is one suitable implementation for a mapping script generation mechanism that allows a user to create a mapping script.

### DETAILED DESCRIPTION

The claims and disclosure herein provide a way to map an incoming data structure to application interface calls using a mapping script that may be maintained by a non-programmer. The logic to perform the mapping is encapsulated in a mapping engine, which may remain constant regardless of the particular incoming data structure or application. The logic that indicates to the mapping engine how to perform the mapping is encapsulated into a user-defined mapping script. The result is a system that can automatically perform mapping from an incoming data structure to a set of application interface calls using a mapping script that may be defined and maintained by a non-programmer, such as a customer.

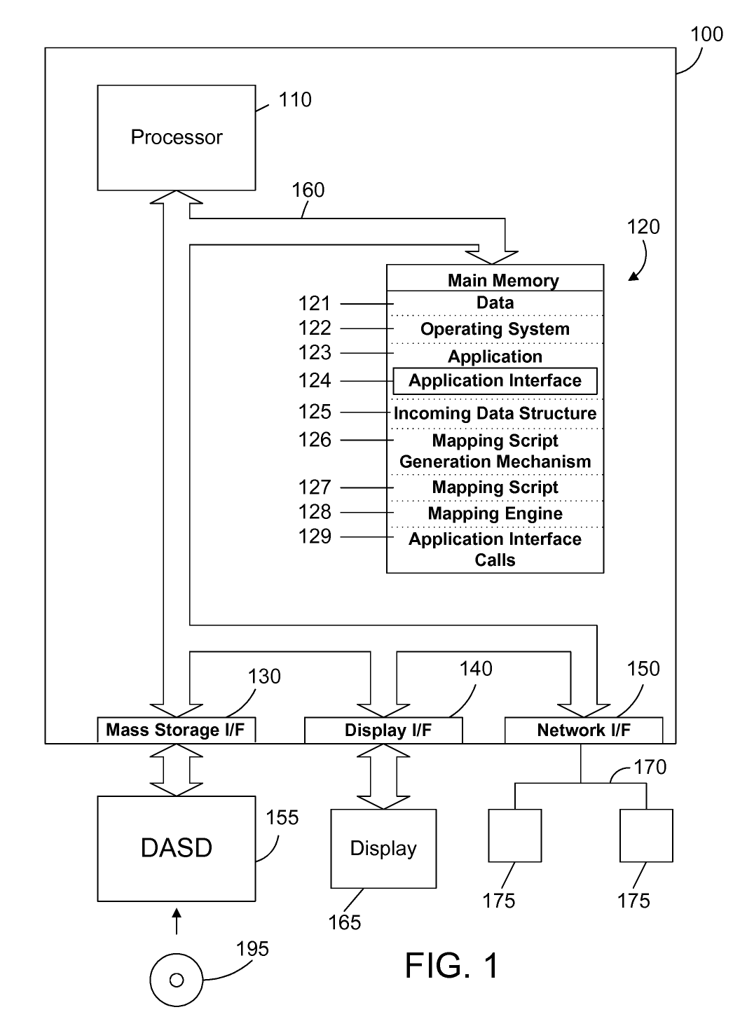

Referring to FIG. 1, a computer system 100 is one suitable implementation of a computer system that includes a mapping engine that reads an incoming data structure, reads a mapping script, and in response, generates one or more calls to an application interface, thereby allowing the incoming data structure to cause certain actions to be taken by an application. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, a software application 123 with a defined application interface 124, an incoming data structure 125, a mapping script generation mechanism 126, a mapping script 127, a mapping engine 128, and application interface calls 129. Data 121 represents any data that serves as input to or output from any program in computer system 100. Operating system 122 is a multitasking operating system known in the industry as i5/OS; however, those skilled in the art will appreciate that the spirit and scope of this disclosure is not limited to any one operating system. Software application 123 is any suitable computer program, such as an application for processing a purchase order. Application interface 124 defines an interface for interacting with application 123. For example, if application 123 is a procedure-based computer program, the application interface 124 will include procedure calls and function calls. If application 123 is an object-based computer program, the application interface 124 will include defined objects and methods on those objects. Application interface 124 expressly includes any suitable interface definition for a software application, whether currently known or developed in the future.

Incoming data structure 125 is data in a defined format. One suitable example of incoming data structure 125 is XML data that could be generated, for example, by a web-based interface that receives information from a user and converts the information into XML data. Mapping script generation mechanism 126 is a software tool that allows a user to define a mapping script 127. Mapping script generation mechanism 126 may include a graphical user interface (GUI) that simplifies the process for the user to generate the mapping script 127. For example, a GUI in mapping script generation mechanism 126 may allow the user to select from a pick list or drop-down list various items corresponding to the incoming data structure and various items corresponding to the application interface, thereby providing a graphical tool that allows a user to easily generate the mapping script 127. The mapping script 127 is a script in any suitable format that contains the information needed to map from the content of the incoming data structure 125 to the application interface 124. The mapping engine 128 is a computer program that reads the incoming data structure 125, reads the mapping script 127, and generates therefrom a set of application interface calls 129 to interact with the application interface 124 in software application 123.

The separation of the mapping script 127 and the mapping engine 128 allows the program code that performs the mapping in the mapping engine 128 to be separate from the logic needed to perform the mapping in the mapping script 127. The result is a mapping engine 128 that is generic to all incoming data structure formats and to all application interfaces. As a result, the mapping engine 128 does not need to change with a change in incoming data structure or application interface. The mapping script 127 encapsulates all the logic to perform the mapping between a particular incoming data structure to a particular application interface. Thus, a single mapping engine 128 may be used to process different combinations of incoming data structure and application interface using different mapping scripts that are each specific to a particular incoming data structure and application interface. The logic that defines the mapping between the incoming data structure and the application interface is encapsulated in the mapping script 127, which is in a format that allows a non-programmer to create and maintain the mapping script 127. The result is a system that can be maintained by a non-programmer.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, application 123, incoming data structure 125, mapping script generation mechanism 126, mapping script 127, mapping engine 128, and application interface calls 129 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that a mapping engine may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

At this point, it is important to note that while the description above is in the context of a fully functional computer system, those skilled in the art will appreciate that the mapping engine may be distributed as an article of manufacture in a variety of forms, and the claims extend to all suitable types of computer-readable media that bear instructions that may be executed by a computer. Examples of suitable computer-readable media include recordable media such as floppy disks and CD-RW (e.g., 195 of FIG. 1).

The mapping engine may also be delivered as part of a service engagement with a client corporation, nonprofit organization, government entity, internal organizational structure, or the like. This may include configuring a computer system to perform some or all of the methods described herein, and deploying software, hardware, and web services that implement some or all of the methods described herein. This may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

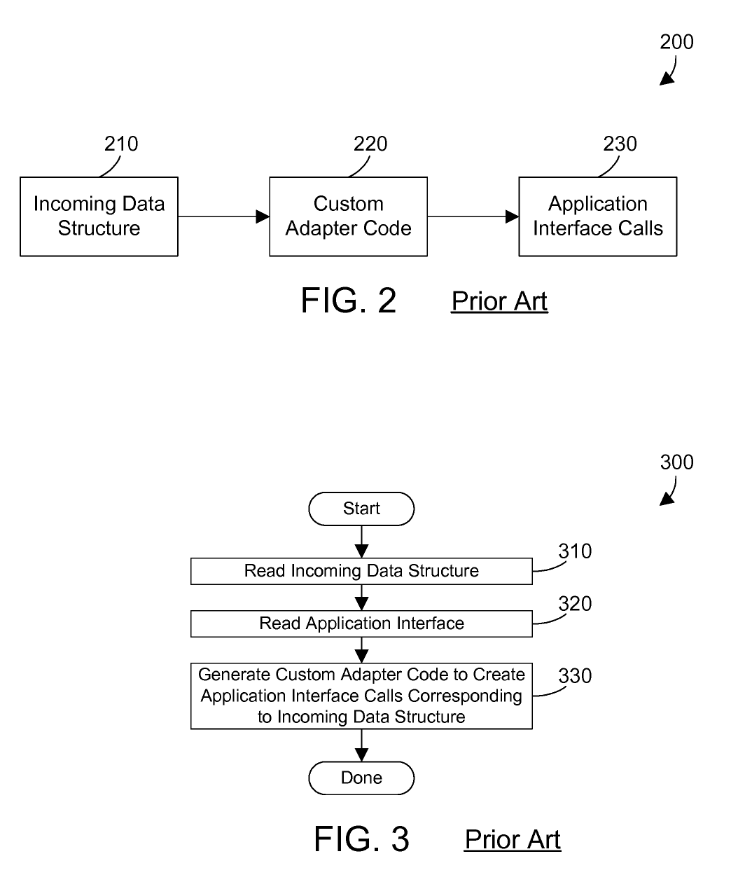

Referring to FIG. 2, a block diagram shows a prior art system 200 for converting an incoming data structure 210 into a corresponding set of application interface calls 230 using custom adapter code 220. The custom adapter code 220 is programmed to provide the desired mapping between a particular incoming data structure 210 and the specific application interface of interest. Referring to FIG. 3, a prior art method 300 reads the incoming data structure 310, reads the application interface 320, and generates custom adapter code to create application interface calls 230 corresponding to the incoming data structure 210 (step 330). Note that custom adapter code 220 is specific to each combination of incoming data structure and application interface. Once programmed, the customer adapter code 220 can read an incoming data structure 210, and generate corresponding application interface calls 230.

One problem with generating custom adapter code as shown in the prior art in FIGS. 2 and 3 is that different custom adapter code 220 is needed for each combination of incoming data structure and application interface. Each must be created and maintained by a skilled computer programmer. Thus, if the definition of an incoming data structure 210 changes to add a new item, the corresponding custom adapter code 220 will have to be updated by a computer programmer to reflect the change. This creates the need for a skilled programmer to maintain the custom adapter code 220.

In the disclosure and claims herein, a mapping engine is created by a skilled programmer, but need not be changed or updated to reflect changes in the incoming data structure or changes in the application interface. The logic to map between the incoming data structure and the application interface is encapsulated in a mapping script that is in a format that may be easily created and maintained by a non-programmer. The result is a system that is more convenient for non-programmers to use because the non-programmers may create and maintain mapping scripts that the mapping engine may process to generate from an incoming data structure one or more calls to an application interface.

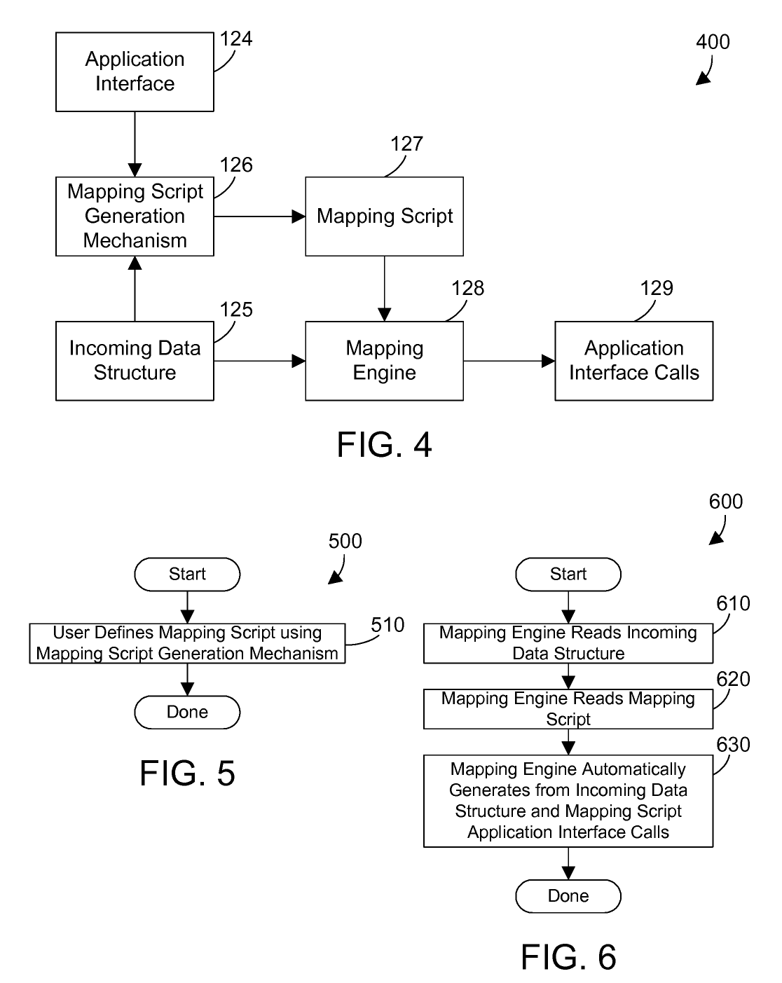

Referring to FIG. 4, a system 400 allows a non-programmer to create and maintain mapping scripts that contain the logic for mapping an incoming data structure to a set of application interface calls. A mapping script generation mechanism 126 reads the application interface 124, reads the incoming data structure 125, and provides a tool for a user to generate a mapping script 127. The mapping script 127, once generated by the user, is used by the mapping engine 128 to create from the incoming data structure 125 a set of application interface calls 129. The mapping engine 128 thus provides an interface between an application interface and an incoming data structure.

Application interface calls 129 may include any suitable way to interact with a software application or computer program. If the application interface is based on procedures, the application interface calls 129 could include procedure calls and function calls. If the application interface is object-based, the application interface calls 129 may include classes and associated methods. The disclosure and claims herein extend to any suitable way to interact with a software application, whether currently known or developed in the future.

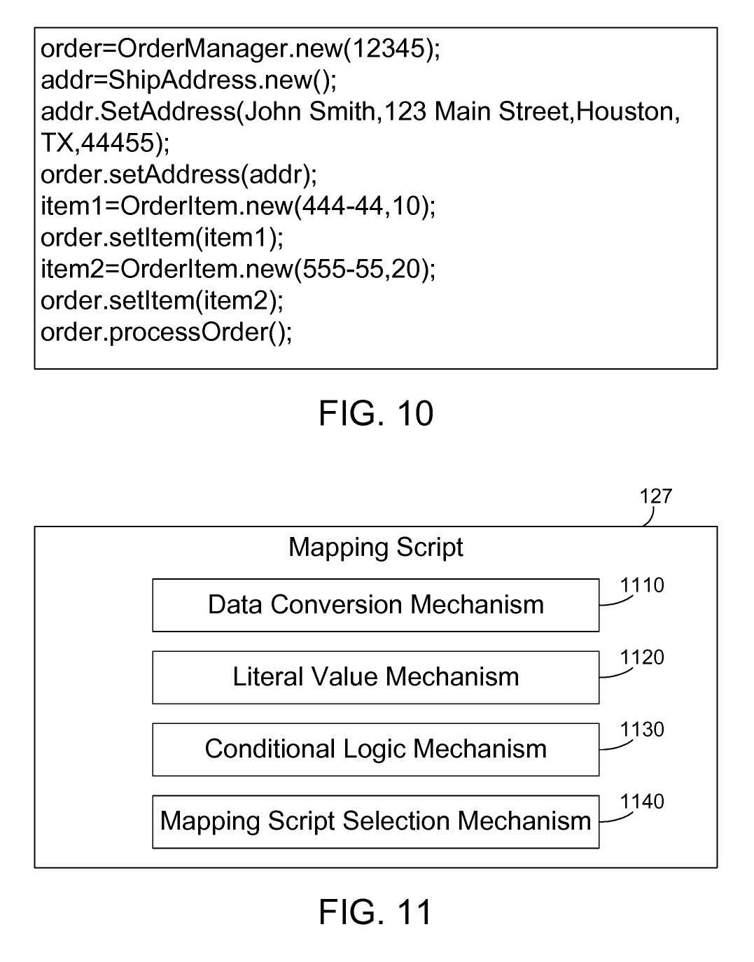

Referring to FIG. 5, a method 500 allows a user to define a mapping script 127 using the mapping script generation mechanism 126 (step 510). The mapping script generation mechanism 126 reads the application interface 124, reads the incoming data structure 125, then provides the user with a software tool for generating the mapping script 127. The mapping script generation mechanism 126 preferably includes a graphical user interface (GUI) that allows the user to graphically correlate elements in the incoming data structure 125 to elements in the application interface 124. One suitable example of a graphical user interface that may be used by the mapping script generation mechanism 126 is shown in FIG. 10.

FIG. 6 shows a method 600 for the mapping engine 128 to create application interface calls from the incoming data structure 125 and from the mapping script 127. The mapping engine reads the incoming data structure (step 610). The mapping engine then reads the mapping script (step 620). From the information read in steps 610 and 620, the mapping engine automatically generates a set of application interface calls 129 (step 630).

The mapping script 127 contains the mappings between a particular incoming data structure and a particular application interface in a format that may be easily created and maintained by a non-programmer. The mapping engine 128 is a computer program that functions according to the logic in the mapping script 127. As a result, a non-programmer may create and maintain multiple mapping scripts without any need for changing the mapping engine 128. By removing the logic for the mapping into the mapping script 127, which may be created and maintained by a non-programmer, system 400 provides a way to more easily and inexpensively create and maintain mappings between incoming data structures and application interfaces.

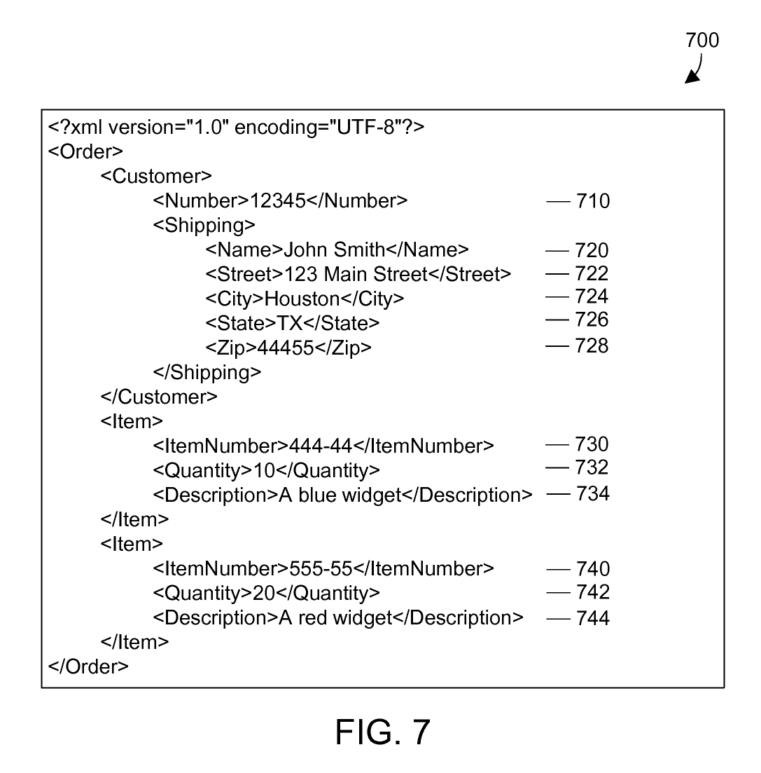

Referring to FIG. 7, a document 700 is one example of a suitable incoming data structure 125 in FIG. 1. Document 700 is in XML format, and defines an order that includes information relating to the customer and items being ordered. We assume this document 700 is generated by a web-based form for this particular example.

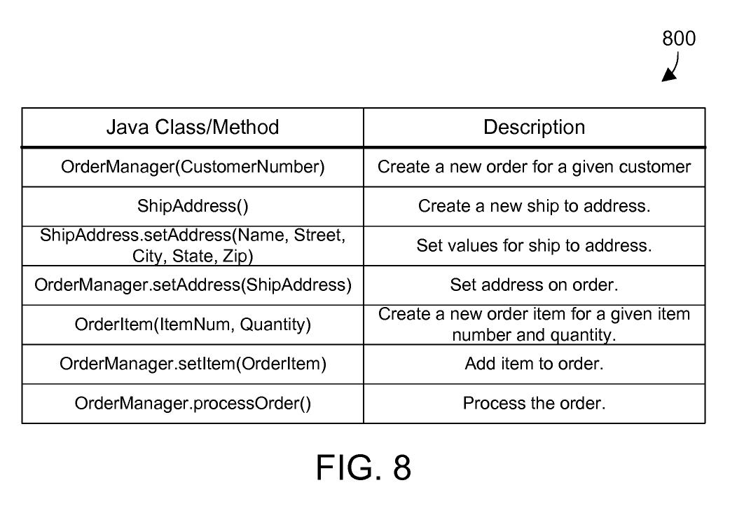

A sample application interface 800 is shown in FIG. 8 as one suitable example of application interface 124 in FIG. 1. In the particular example shown in FIG. 8, application interface 800 is an object-based interface that defines Java classes and methods. For example, the OrderManager class is invoked, passing a CustomerNumber as a parameter, to create a new order for a given customer. A ShipAddress( ) class is invoked to create a new ship to address for the customer. A setAddress( ) method on the ShipAddress class is invoked, passing Name, Street, City, State and Zip as parameters, to set the values of the ship to address. A setAddress( ) method on the OrderManager class is invoked, passing the ShipAddress as a parameter, to set the address for the order. An OrderItem( ) class is invoked, passing ItemNum and Quantity as parameters, to create a new order item for a given item number and quantity. A setItem( ) method is invoked on the OrderManager class, passing OrderItem as a parameter, to add the order item to the order. A processOrder( ) method is invoked on the OrderManager class to process the order.

One can easily see that the incoming data structure 700 in FIG. 7 is incompatible with the application interface 800 shown in FIG. 8 because the incoming data structure 700 includes data, but does not invoke any methods on any objects. As a result, a mapping needs to be made to convert the incoming data structure 700 in FIG. 7 to a set of application interface calls for the application interface 800 in FIG. 8. The logic for the conversion may be encapsulated in a suitable mapping script.

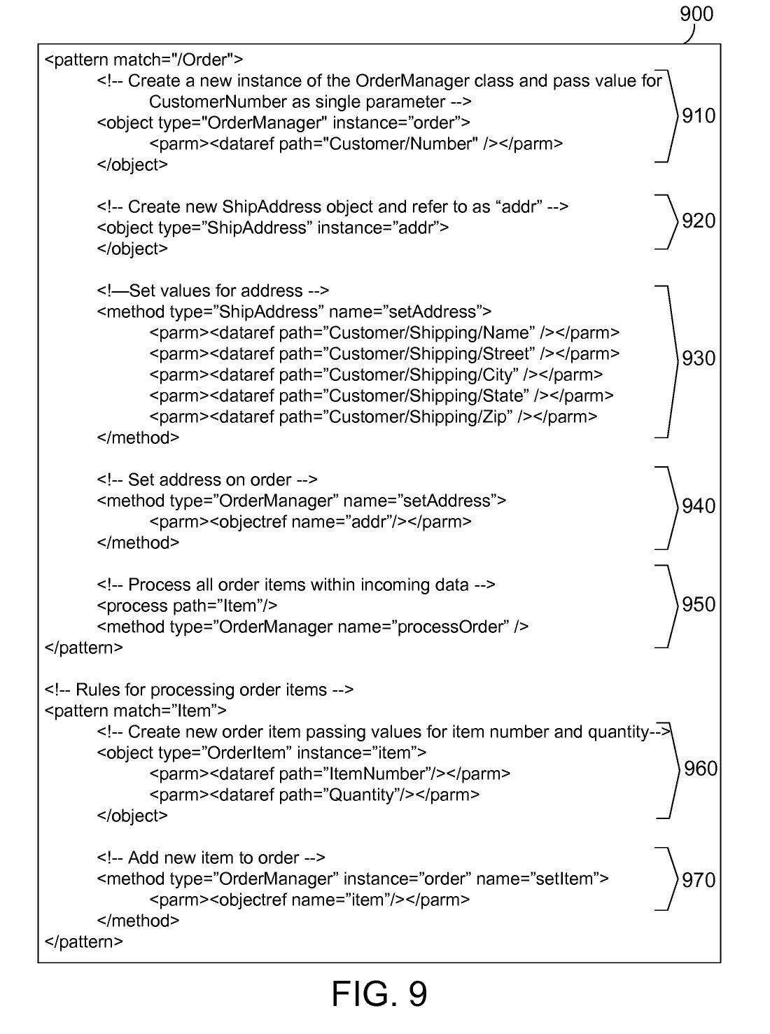

A sample mapping script 900 is shown in FIG. 9 that provides the appropriate logic for mapping the incoming data structure 700 in FIG. 7 to appropriate method calls on the application interface 800 shown in FIG. 8. We assume this mapping script was created by a user using a suitable mapping script generation mechanism 126. Note that mapping script 900 is not computer code, and may therefore be created and maintained by a non-programmer. Rather, the mapping script represents an association between elements of the incoming data structure and parameters defined on the various function or method interfaces supported by the application. In addition, the mapping script prescribes an order in which functions or methods within the application interface are invoked. This ordering may be explicitly defined by the mapping script, or may be driven by the order in which items appear in the incoming data structure.

Portion 910 in FIG. 9 shows the mapping to create a new instance of the OrderManager class and pass the CustomerNumber as a parameter. The parameter for the method call is defined to reside in the Customer/Number element 710 in FIG. 7. Portion 920 shows the mapping to create a new ShipAddress object called “addr”. Portion 930 shows methods for setting values for the shipping address when invoking the ShipAddress object, and specifies the mapping from elements in the incoming data structure 700 in FIG. 7 to the parameters for the ShipAddress.setAddress method call in FIG. 8. The first parameter to the ShipAddress.setAddress method is Name, which corresponds to the Customer/Shipping/Name element 720 in the incoming data structure 700. The second parameter to the ShipAddress.setAddress method is Street, which corresponds to the Customer/Shipping/Street element 722 in the incoming data structure 700. The third parameter to the ShipAddress.setAddress method is City, which corresponds to the Customer/Shipping/City element 724 in the incoming data structure 700. The fourth parameter to the ShipAddress.setAddress method is State, which corresponds to the Customer/Shipping/State element 726 in the incoming data structure 700. The fifth parameter to the ShipAddress.setAddress method is Zip, which corresponds to the Customer/Shipping/Zip element 728 in the incoming data structure 700.

Portion 940 in FIG. 9 defines how to set an address on an order by invoking the setAddress method on the OrderManager class, passing the ShipAddress object “addr” as the parameter to the call. Portion 950 defines how to process all order items, then calls the processOrder( ) method on the OrderManager class.

The rules for processing order items are shown in portions 960 and 970 in FIG. 9. Portion 960 creates a new order item by passing values for the item number and quantity. For an instance called “item” of the OrderItem class, the first parameter is ItemNum, which corresponds to the ItemNumber elements 730 and 740 in FIG. 7. The second parameter is Quantity, which corresponds to the Quantity elements 732 and 734 in FIG. 7. Note the descriptions 734 and 744 shown in FIG. 7 are not necessarily used in mapping the incoming data structure 700 to the application interface 800, but are present to make the type of item more easily readable by a human. This shows that a subset of data in the incoming data stream 700 may be used to generate the corresponding application interface calls without using all of the data in the incoming data stream 700. Portion 970 in FIG. 9 is used to add a new item to an order. The setItem( ) method on the OrderManager instance is invoked, passing the OrderObject instance “item” as a parameter.

Once the mapping script (e.g., 900) is defined that contains the logic for mapping the incoming data structure (e.g., 700) onto the corresponding application interface (e.g., 800), the mapping engine may easily generate an appropriate set of calls to the application interface that causes the application to perform desired functions with respect to the data in the incoming data structure. A set of application interface calls for this specific example is shown as 1000 in FIG. 10, which is one suitable example of application interface calls 129 in FIG. 1. The application interface calls 1000 in FIG. 10 create an order in the application from the data in the incoming data structure 700.

Note that the set of function or method calls generated by the mapping engine is not fixed and is driven by the nature of the incoming data structure. For example, if an incoming data stream defines a purchase order with three order items instead of two, there would be three OrderItem objects generated and three calls to order.setItem( ) instead of two. In addition, various mechanisms could be included in the mapping script to enhance the function of the mapping script. Examples of mechanisms that may be optionally included in the mapping script 127 are shown as mechanisms 1110, 1120, 1130 and 1140 in FIG. 11.

The data conversion mechanism 1110 could perform conversion of data found within the incoming data structure to the format suited for the application interface. For example, if price in the incoming data structure is in Yen and the application interface expects U.S. dollars, the data conversion mechanism 1110 in the mapping script 127 could prescribe a transform that needs to be performed to convert incoming values from the data structure to the format required by the application interface. This could be an explicit mapping defined within the mapping script (e.g., convert “1” to “true” and “0” to “false”) or could be a call to an external function or web service that performs the necessary conversion. The literal value mechanism 1120 could provide literal values (e.g., always pass the value of “true” for a given parameter) and could define default values to use in the absence of an appropriate value being found within the incoming data structure. The conditional logic mechanism 1130 could specify some conditional logic that is applied (e.g., if quantity is greater than 100, use 25% as the customer discount). The mapping script selection mechanism 1140 allows selecting one mapping script to use from multiple defined mapping scripts based on some pattern found within the incoming data structure. For example, there could be two different mapping scripts for an order, one that deals with orders using credit card numbers and one dealing with orders specifying purchase order numbers. Each of these different order types could very likely drive a different set of application interface calls. The mapping script selection mechanism 1140 could select the first mapping script if a credit card number was found in the incoming data structure and select the second mapping script if a purchase order number was specified. This would allow a single instance of a mapping engine to receive a variety of different types of data structures with the ability to associate the appropriate mapping script to use based on a given pattern found within the data structure.

The mapping engine and mapping script provide a very powerful and flexible combination that allows the mapping engine to remain constant while mapping scripts are created or changed in a format that allows a non-programmer to perform the creation or modification of the mapping scripts.

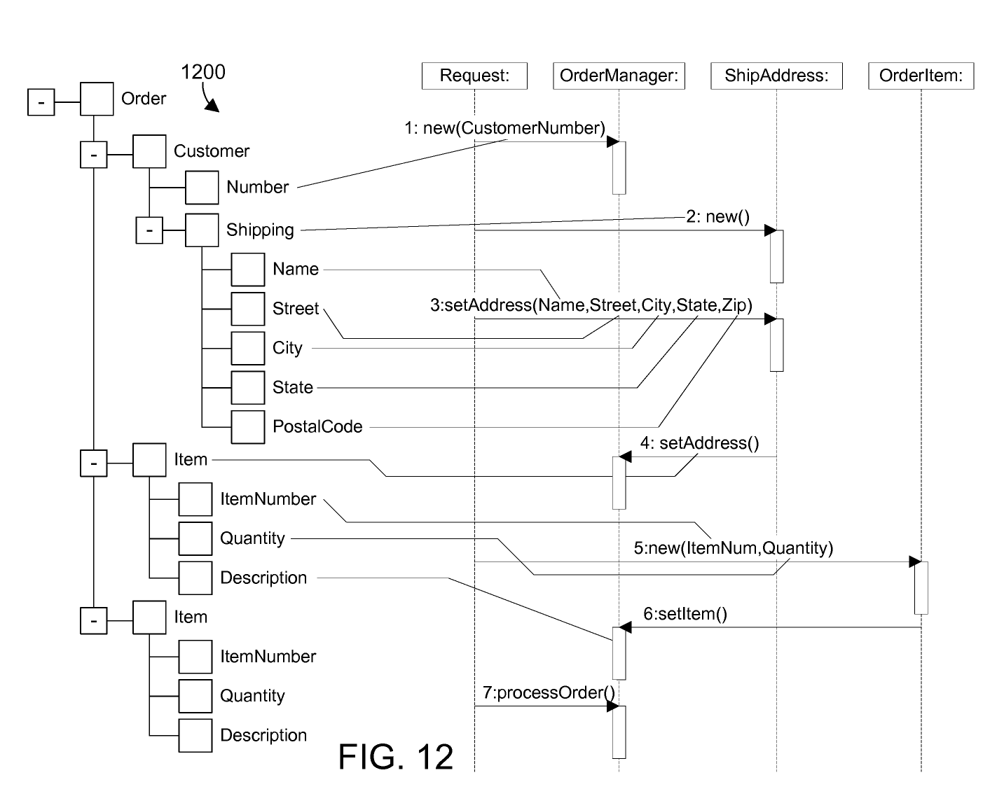

In the most preferred implementation, the mapping script generation mechanism 126 includes a graphical user interface that allows a user to quickly and easily correlate the incoming data structure to the application interface. One suitable example of a graphical user interface is shown in display 1200 in FIG. 12, which includes the elements in the incoming data stream on the left, and the object interactions for the application interface on the right. A user may then drag and drop elements, or connect elements with lines, etc. to establish a correlation between elements. The lines from the left side to the right side of the display in FIG. 10 show the correlation between the data in the incoming data structure and the methods and objects in the application interface. This graphical user interface helps a user, including a non-programmer, to generate a suitable mapping script without the need for the user to be a skilled computer programmer. As a result, a customer may have sufficient knowledge to create and maintain mapping scripts without requiring the support of a skilled programmer. Note also the details of the mapping script shown in FIG. 9 may not be visible to the user that creates and maintains the mapping scripts because the graphical user interface shown in display 1200 in FIG. 12 could effectively translate the GUI representation shown in FIG. 12 to the representation 900 shown in FIG. 9 in a manner that is not visible to the user.

The disclosure and claims herein provide a mapping engine that maps an incoming data structure to a set of application interface calls using a user-defined mapping script that is in a format that allows a non-programmer to create and maintain the mapping script. The result is a system that may be easily changed and updated by a non-programmer redefining the mapping scripts to accommodate any changes to the incoming data stream or application interface.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1) An apparatus comprising:
at least one processor;
a memory coupled to the at least one processor;
an incoming data structure residing in the memory;
an application interface for calling a software application;
a mapping script residing in the memory that provides logic to map the incoming data structure to the application interface; and
a mapping engine residing in the memory and executed by the at least one processor that reads the incoming data structure, reads the mapping script, and in response, generates at least one call to the application interface to cause the software application to perform at least one function corresponding to the incoming data structure.

2) The apparatus of claim 1 further comprising a mapping script generation mechanism that allows a user to define the mapping script.

3) The apparatus of claim 2 wherein the mapping script generation mechanism comprises a graphical user interface.

4) The apparatus of claim 1 wherein the mapping script comprises at least one mechanism selected from the group: a data conversion mechanism that converts data from a first format in the incoming data stream to a second format expected by the application interface; a literal value mechanism that provides a literal value as a parameter to a call to the application interface; a conditional logic mechanism that changes at least one parameter to the at least one call to the application interface when a defined condition is satisfied; and a mapping script selection mechanism that allows determining which of a plurality of mapping scripts to use based on the incoming data structure.

5) The apparatus of claim 1 wherein the mapping script is in a format that allows a non-programmer to create and maintain the mapping script.

6) The apparatus of claim 1 wherein mapping engine comprises a computer program that can generate at least one call to any suitable application interface from any suitable incoming data structure based solely on the mapping script.

7) A computer-implemented method for generating at least one call to an application interface from an incoming data structure, the method comprising the steps of:
(A) reading the incoming data structure;
(B) reading a mapping script that provides logic to map the incoming data structure to the application interface; and
(C) generating at least one call to the application interface to cause a software application to perform at least one function corresponding to the incoming data structure.

8) The method of claim 7 further comprising the steps of:
a mapping script generation mechanism reading the incoming data structure and reading the application interface; and
the mapping script generation mechanism providing tools that allows a user to define the mapping script.

9) The method of claim 7 further comprising the step of a user defining the mapping script.

10) The method of claim 9 wherein the user defines the mapping script using a graphical user interface.

11) The method of claim 7 wherein the mapping script comprises at least one mechanism selected from the group: a data conversion mechanism that converts data from a first format in the incoming data stream to a second format expected by the application interface; a literal value mechanism that provides a literal value as a parameter to a call to the application interface; a conditional logic mechanism that changes at least one parameter to the at least one call to the application interface when a defined condition is satisfied; and a mapping script selection mechanism that allows determining which of a plurality of mapping scripts to use based on the incoming data structure.

12) The method of claim 7 wherein the mapping script is in a format that allows a non-programmer to create and maintain the mapping script.

13) The method of claim 7 wherein step (C) is performed by a mapping engine that comprises a computer program that can generate at least one call to any suitable application interface from any suitable incoming data structure based solely on the mapping script.

14) A computer-implemented method for generating at least one call to an application interface from an incoming data structure, the method comprising the steps of:
reading the incoming data structure and reading the application interface;
providing a graphical user interface that allows a user to define a mapping script that provides logic to map the incoming data structure to the application interface in a format that allows a non-programmer to create and maintain the mapping script;
a user using the graphical user interface to define the mapping script, the mapping script including a data conversion mechanism that converts data from a first format in the incoming data stream to a second format expected by the application interface, a literal value mechanism that provides a literal value as a parameter to a call to the application interface, a conditional logic mechanism that changes at least one parameter to the at least one call to the application interface when a defined condition is satisfied, and a mapping script selection mechanism that allows determining which of a plurality of mapping scripts to use based on the incoming data structure;
reading the incoming data structure;
the mapping script selection mechanism selecting which of a plurality of mapping scripts to use based on the incoming data structure;
reading the selected mapping script; and
generating at least one call to the application interface to cause a software application to perform at least one function corresponding to the incoming data structure, the at least one call to the application interface comprising data received from the data conversion mechanism, a literal value received from the literal value mechanism, a parameter changes by the conditional logic mechanism.

15) An article of manufacture comprising:
a mapping engine that reads an incoming data structure, reads a mapping script that provides logic to map the incoming data structure to an application interface, and in response, generates at least one call to the application interface to cause a software application to perform at least one function corresponding to the incoming data structure; and
computer-readable media bearing the mapping engine.

16) The article of manufacture of claim 15 further comprising a mapping script generation mechanism that allows a user to define the mapping script.

17) The article of manufacture of claim 16 wherein the mapping script generation mechanism comprises a graphical user interface.

18) The article of manufacture of claim 15 wherein the mapping script comprises at least one mechanism selected from the group: a data conversion mechanism that converts data from a first format in the incoming data stream to a second format expected by the application interface; a literal value mechanism that provides a literal value as a parameter to a call to the application interface; a conditional logic mechanism that changes at least one parameter to the at least one call to the application interface when a defined condition is satisfied; and a mapping script selection mechanism that allows determining which of a plurality of mapping scripts to use based on the incoming data structure.

19) The article of manufacture of claim 15 wherein the mapping script is in a format that allows a non-programmer to create and maintain the mapping script.

20) The article of manufacture of claim 15 wherein mapping engine comprises a computer program that can generate at least one call to any suitable application interface from any suitable incoming data structure based solely on the mapping script.
